(19) United States
(12) Patent Application Publication
(10) Pub. No.: US 2002/0130480 A1
(43) Pub. Date: Sep. 19, 2002

(54) Variable compliance pivot assembly and suspension system for use therewith

(76) Inventor: Ervin VanDenberg, Massillon, OH (US)

Correspondence Address: Joseph A. Sebolt, Sand & Sebolt, Aston Park Professional Centre, Suite 194, 4801 Dressler Rd. NW, Canton, OH, 44718, US

(21) Appl. No.: 09/808,473

(22) Filed: Mar. 14, 2001

(51) Int. Cl. B60G 1/00

(52) U.S. Cl. 280/124.116; 280/124.1

(57) ABSTRACT

A pivot assembly for use in a vehicle suspension system includes a bushing having a constant cross sectional configuration and having a cylindrical hole formed therein. The bushing is positioned within a bushing seat, which is non-complimentary shaped with respect to the bushing and provides cavities for around the bushing so to permit defined deflection of the bushing under load.

### BACKGROUND OF THE INVENTION

1. Technical Field

The invention relates generally to suspension systems. More particularly, the invention relates to an improved bushing that provides variable compliance in response to different loading conditions, with the bushing being relatively simple to install. Specifically, the invention relates to a bushing that provides a compliance in the horizontal direction that is different than the compliance in the vertical direction whereby the bushing and bushing seat are non-complimentary shapes.

2. Background Information

With the advent following World War II of large load carrying capacity trucks and trailers in this country, came the need to control the movement of suspension systems relative to the truck frame.

Additionally, the trucking industry has witnessed a dramatic increase with the costs associated with the transportation of goods. High costs and increased competition mandated that over-the-road vehicles be utilized as efficiently as possible to minimize expense and maximize productivity. The trucking industry is, therefore, in a constant search to improve truck efficiency and cost by reducing truck weight and by increasing the stability of the vehicle so that ever increasing loads may be carried.

The bushings associated with truck suspension systems provide a coupling between the vehicle's frame and the vehicle suspension beam to which the vehicle axle and wheels are connected.

A typical trailing arm suspension system utilizes the suspension beam having a bushing seat at one end for holding a bushing therein. The bushing typically contains a bearing formed with a cylindrical hole, for receiving a hollow journal which holds a pin. The pin is attached to a hanger bracket extending downwardly from the vehicle frame to provide rotational connection between the beam and the vehicle frame. The beam is generally connected along its length or at the opposite end, to the vehicle axle which, in turn, supports the vehicle wheels.

Suspension system bushings are subjected to a wide variety of loads. Longitudinal loads resulting from acceleration and braking are transmitted along the length of the beam to the bushing. Vertical loads result from a wheel on one side of the truck traversing an obstruction that the corresponding wheel on the other side of the truck does not traverse, such as when one side of the truck traverses a curb. Additionally, vertical loading may occur when the truck travels around a corner, such that centrifugal force causes the truck weight to be pushed outwardly such that a majority of the weight is carried on the wheels associated with the outside of the turn.

Rotational forces result from compression of the suspension system due to vehicle loading and unloading and due to the vehicle traversing obstructions in the road surface and are transmitted from the wheels to the bushing by rotation of the beam about the pin.

Bushings are often manufactured of materials having elastomeric properties such that the bushings act in conjunction with springs and shock absorbers to provide an additional level of isolation between the vehicle frame and the vehicle wheels. Since the magnitude and duration of the aforementioned loading forces and torques differ considerably, it is often desirable to design a bushing to provide multiple compliances whereby the bushing reacts differently to the various loading phenomena. For instance, a bushing may posses a first compliance to respond to a given set of forces as well as a lower compliance along a different axis to respond to higher forces occurring along that axis. Additionally, the need may exist for a suspension to react to forces differently in the X, Y and Z axis, even if the force magnitudes are similar in order to maintain a stable ride.

Such loading is typical of trailing arm suspensions and is well understood in the relevant art. Moreover, bushings having different compliances responsive thereto are similarly known and understood in the relevant art. Various bushings, all of which are known in the art, have been employed in various combinations to counteract the effect of such forces with varying degrees of success. Such bushings have often been difficult to install and have required specialized tools such as high tonnage presses. Moreover, bushings responsive to the aforementioned loading phenomena have typically been costly, difficult to install, and some of them have a limited useful life. Thus, the need exists for bushing providing varying compliance along multiple axes that are inexpensive, easy to install and have an economical service life. Still further, the need exists for suspension systems utilizing various compliance bushings which permit traditional, off the shelf bushings to be used in bushing seats whereby the interaction of the bushing and bushing seat provide for variable compliance along multiple axes.

### SUMMARY OF THE INVENTION

In view of the foregoing, the objectives of the invention are set forth in the following description and are set forth in the appended claims.

Additional objectives of the invention include providing a suspension system for supporting a vehicle comprising at least one beam adapted for supporting a vehicle, a pivot assembly attached to one end of the beam, said pivot assembly including a bushing and a bushing seat, and the bushing being non-complimentary shaped to the bushing seat.

Additionally, the invention contemplates a method of controlling the deflection of the bushing comprising providing an elastomeric bushing, providing a bushing seat having a first cavity surrounding at least a portion of the bushing, providing at least a second cavity in communication with the first cavity and adjacent to bushing, applying a first force on the bushing in a first direction, reacting the first force on the wall of the first cavity, applying a second force to the bushing in a direction different from the first force, and deflecting the bushing at least partially into the second cavity as a result of the second force.

### BRIEF DESCRIPTION OF THE DRAWINGS

The preferred embodiment of the invention, illustrative of the best mode in which applicant contemplated applying the principles, is set forth in the following description and is shown in the drawings and is particularly and distinctly pointed out and set forth in the appended claims.

FIG. 1 is a side view of a typical trailing arm suspension system;

FIG. 2 is a top plan view of a typical beam and hanger bracket assembly;

FIG. 3 is a perspective view of the bushing assembly of the present invention;

FIG. 4 is a sectional view taken along line 4-4, FIG. 2, with portions cut away and in section;

FIG. 5 is a sectional view taken along line 5-5, FIG. 4, with further portions cut away;

FIG. 6 is an operational view similar to FIG. 4 with forces acting upwardly on the trailing beam;

FIG. 7 is an operational view similar to FIG. 6 with forces acting downwardly on the suspension beam;

FIG. 8 is a sectional view of a hanger bracket and trailing beam of a second embodiment of the present invention with portions cut away and shown in section;

FIG. 9 is a sectional view taken along line 9-9, FIG. 8;

FIG. 10 is a sectional view of a hanger bracket and trailing beam of a third embodiment of the present invention with portions cut away and shown in section;

FIG. 11 is a sectional view taken along line 11-11, FIG. 10;

FIG. 12 is a sectional view of a hanger bracket and trailing beam of a fourth embodiment of the present invention with portions cut away and shown in section;

FIG. 13 is a sectional view taken along line 13-13, FIG. 12;

FIG. 14 is a sectional view taken along line 14-14 of FIG. 13;

FIG. 15 is a sectional view of a hanger bracket and trailing beam of a fifth embodiment of the present invention with portions cut away and shown in section;

FIG. 16 is a sectional view taken along line 16-16, FIG. 15; and

FIG. 17 is a sectional view taken along line 17-17 of FIG. 16.

Similar numerals refer to similar parts throughout the drawings and specification.

### DESCRIPTION OF THE PREFERRED EMBODIMENTS

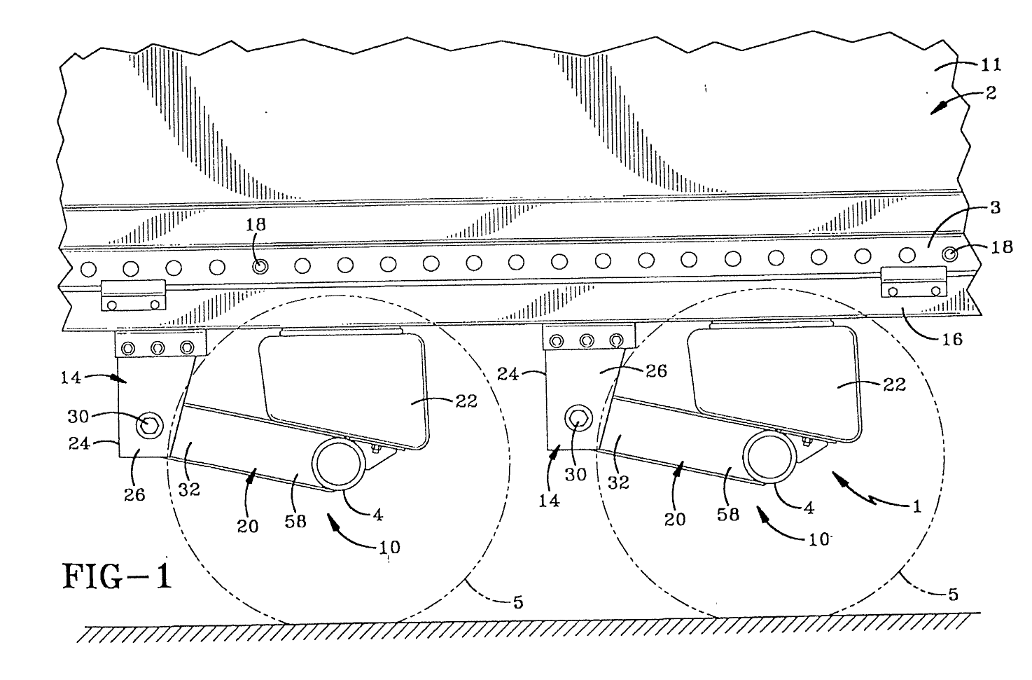

The improved suspension system of the present invention is indicated generally at 1, and is shown installed on a vehicle 2 having a pair of frame or slider rails 3 and an axle 4. Axle 4 supports a pair of tire wheel assemblies 5 as shown in FIG. 1. Multiple suspension systems 1 may be provided on a single vehicle and may be of the trailing arm type shown in FIG. 1, or may be leading beam suspension systems or parallelogram suspension systems without departing from the spirit of the present invention. As also is shown in FIG. 1, suspension system 1 includes a pair of suspension assemblies 10, only one side of which is shown in FIG. 1. Since the assemblies are similar to each other, one being the mirror image of the other, and joined by axle 4, only one suspension assembly 10 is shown and described in the specification. Vehicle 2 includes a cargo box 11 for carrying various types of cargo, which cargo box is supported on frame rails 3.

Suspension system 1 includes a pair of suspension assemblies 10 with each suspension assembly 10, in turn including, a hanger bracket 14 connected to one of a pair of parallel and spaced apart slide channels 16. Slide channels 16 are spaced apart a distance equal to the distance between frame rails 3 and are mounted to frame rails 3 with a plurality of locking pins 18. Each suspension assembly 10 also includes a beam 20 mounted at one end to hanger bracket 14 and supporting axle 4 at its opposite end. An air spring 22 is positioned intermediate beam 20 and vehicle 2.

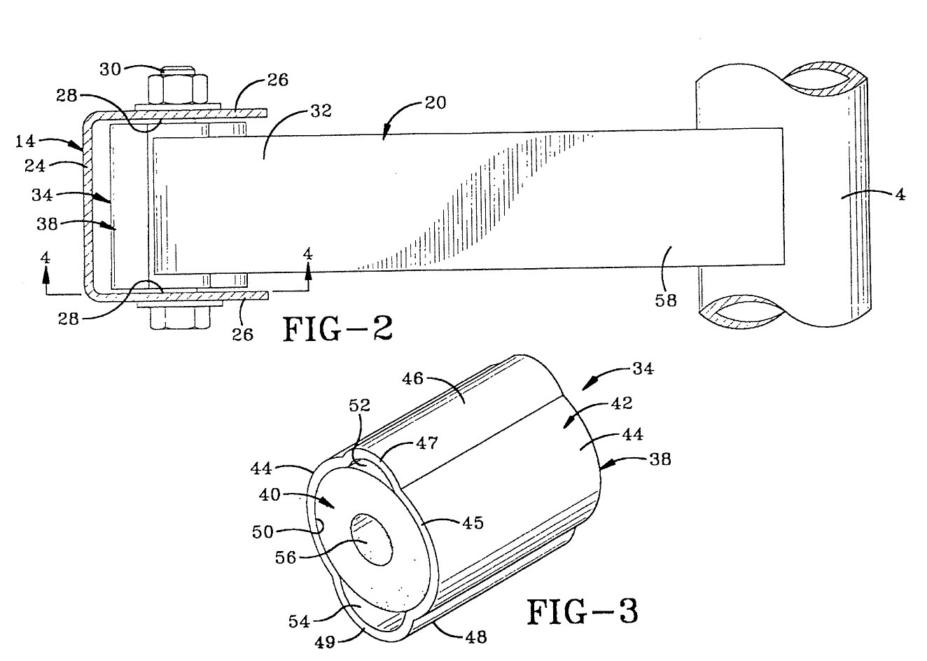

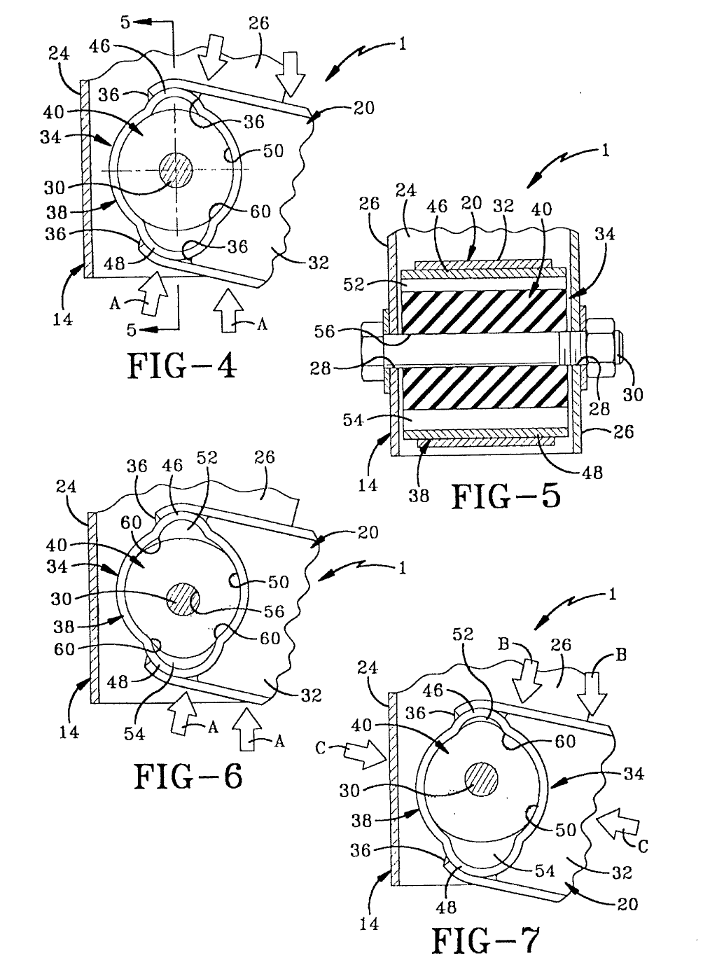

Referring next to FIG. 2, hanger bracket 14 includes an end wall 24 and a pair of parallel and spaced apart sidewalls 26. Each sidewall 26 includes an aperture 28 through which a bolt or pin 30 extends. Beam 20 has a first end 32 securely welded to a pivot assembly 34 at welds 36 (FIG. 4). Pivot assembly 34 is more particularly shown in FIG. 3 and includes a bushing seat 38 and a bushing 40. Bushing seat 38 includes a continuous sidewall 42 having a non-constant radius of curvature. Sidewall 42 includes a pair of sides 44 which have constant circumference, a top 46 having a radius of curvature smaller then sides 44 and a bottom having a radius of curvature smaller then sides 44, but larger than top 46. In accordance with one of the main features of the present invention, sides 44 have a perimeter 45 defining a first cavity 50. Perimeter 45 is continuous and does not extend all the way around cavity 50. Top 46 defines a second cavity 52 and bottom 48 defines a third cavity 54. Each of top 46 and bottom 48 define respective perimeter walls 47 and 49, respectively. First cavity 50 is generally complimentary shaped to bushing 40 with second cavity 52 and third cavity 54 extending upwardly and downwardly, respectively relative to first cavity 50 and bushing 40. Bushing 40 extends within first cavity 50 and, as will be more fully described below, when not under stress, does not extend substantially into second cavity 52 and third cavity 54. Bushing 40 includes a through aperture 56 which is sized to receive bolt or pin 30 and when positioned intermediate sidewalls 26 of hanger bracket 14 axially aligns with apertures 28 formed in sidewalls 26 to permit the mounting of beam 20 to hanger bracket 14 at bolt 30.

Beam 20 may take a variety of configurations, but in the present invention, it is substantially square in cross sectional configuration and includes a second end 58 mounted to axle 4.

Referring next to FIG. 4, and in accordance with one of the features of the invention, bushing 40 of pivot assembly 34 is preferably manufactured of a tough material having elastomeric properties such as polyurethane. Bushing 40 is configured to fit within bushing seat 38 with a minimum of effort such that no special tools are required to position bushing 40 within bushing seat 38. It should also be understood that bushing 40 may take a variety of configurations and shapes so long as it remains non-complimentary shaped to bushing seat 38, as will be more fully described below.

In accordance with one of the main features of the present invention, pivot assembly 34 provides for a variable spring rate of the pivot assembly in the vertical direction relative to the horizontal direction. More specifically, variable compliance of pivot assembly 34 is provided in that bushing 40 is provided to have constant wall thickness and interferencely abuts sides 44 of bushing seat 38. However, bushing 40 does not contact top 46 or bottom 48 of bushing seat 38, thus providing a first cavity 50 and a second cavity 52 positioned above and below bushing 40, respectively. As such, when force is applied in the direction of arrow A (FIG. 6), beam 20 is moved upwardly and bushing 40 may be squeezed, or deflected, into third cavity 54 created by bottom 48 of bushing seat 38. When this happens, the pivot assembly 34 is more compliant in the vertical direction than the horizontal direction. This can be further seen from FIG. 6, bushing 40 when drawn into cavity 54 as a result of upward movement of beam 20 along the direction of arrow A, the material is actually drawn away from second cavity 52 and top 46 of bushing seat 38 and actually will no longer fill first cavity 50 along the top portion thereof. Although bushing 40 is elastomeric and will move as force is applied to the beam around it, it is not compressable. Third cavity 54 thus, provides a space to receive the bottom of bushing 40 when in vertical compression. Bushing 40 moves fluidly into third cavity 54 and out of first cavity 50 assuring that bushing 40 takes up the same amount of volume, regardless of the bushing stress load.

Similarly referring to FIG. 7, when force is applied in the direction of arrow B, bushing 40 will move fluidly into second cavity 52 away from third cavity 54 and slightly out of first cavity 50. Forces acting in the direction of A occur during diagonal axle walk when tire wheel assembly 5 associated with the beam shown in FIG. 6 is the one traversing the curb, or alternatively, when the vehicle travels around a bend and centrifugal forces causes the box to sway away from the arc of the curve. Conversely, the suspension system will experience force acting in the direction of arrow B downwardly on beam 20, during diagonal axle walk when beam 20 as shown in FIG. 7, is the beam remaining positioned on the ground and not being forced over a curb. Similarly, the outside wheels of the vehicle will experience force in the direction of arrow B as the vehicle travels around a bend. As can be seen, second cavity 52 and third cavity 54 of the present embodiment of the invention, are shown to have different sizes such that pivot assembly 34 is more compliant when force is applied in the direction of arrow A (FIG. 6) then when force is applied in the direction of arrow B (FIG. 7). There are various reasons for providing variable compliance in the vertical direction based on the direction of force based on the need to stabilize the load. However, second cavity 52 and third cavity 54 may take a variety of sizes and configurations without departing from the spirit of the present invention. Additionally, an arcuate transition between the respective cavities is beneficial in that it will extend the life of bushing 40 due to its fluid, elastic nature.

Bushing seat 38 may also be manufactured with sharp transitions between first cavity 50, second cavity 52 and third cavity 54 without departing from the spirit of the present invention. Still further, it is shown that second cavity 52 and third cavity 54 are shown substantially vertically such that pivot assembly 34 is more compliant in the vertical direction then the horizontal direction. However, cavities could be provided around the perimeter of sidewall 42 to change the compliance of the bushing based on the particular needs of the bushing without departing from the spirit of the present invention. Bushing 40 may also be non-circular so long as a cavity is provided in the axle seat to accept the deflection of bushing 40 when it is loaded.

Still referring to FIG. 7, it can be seen that when horizontal force is provided along the length of beam 20, as shown specifically by arrow C, bushing 40 will flow much less given that it is direct contact with sides 44 of first cavity 50. However, based on the durometer of the bushing 40, a small portion of bushing 40 may still travel into second cavity 52 and third cavity 54 to provide a more compliant bushing in the horizontal direction. However, if a harder durometer bushing is provided, very little material will flow into second cavity 52 and third cavity 54, and the majority of the material will stay within first cavity 50 providing a rigidly compliant bushing in the horizontal direction. Horizontal force will act on the bushing along the direction of arrow C if, for example, the tire wheel assembly abuts a large curb which is difficult to overcome, and during brake reaction when the vehicle brakes are applied to the tractor trailer assembly.

Longitudinal forces C are of a nature and magnitude different then vertical forces A and B. Thus, the varying compliances provided by pivot assembly 34 help bushing 40 isolate cargo box 11 from the various forces encountered by vehicle 2 better then a bushing having a single constant compliance.

The varying compliances of pivot assembly 34 further assist bushing 40 in maintaining the stability and control of vehicle 2. While longitudinal forces C operate along the length of beam 20, and in turn, along the length of vehicle 2, vertical forces operate vertically with respect to hanger bracket 14, thereby causing vehicle 2 to rotate about an axis parallel the vehicle length. Vertical forces A and B can potentially cause vehicle 2 to tip over if vertical forces A and B are of sufficient magnitude are transmitted through hanger bracket 14 to vehicle 2 without compliance of bushing 40. Thus, the compliance of bushing 40 must be configured to isolate vehicle 2 from longitudinal forces C while at the same time preventing tip over due to vertical forces A and B. Additionally, a bushing which provides for second cavity 52 and third cavity 54 will have a tailored compliance for conical force.

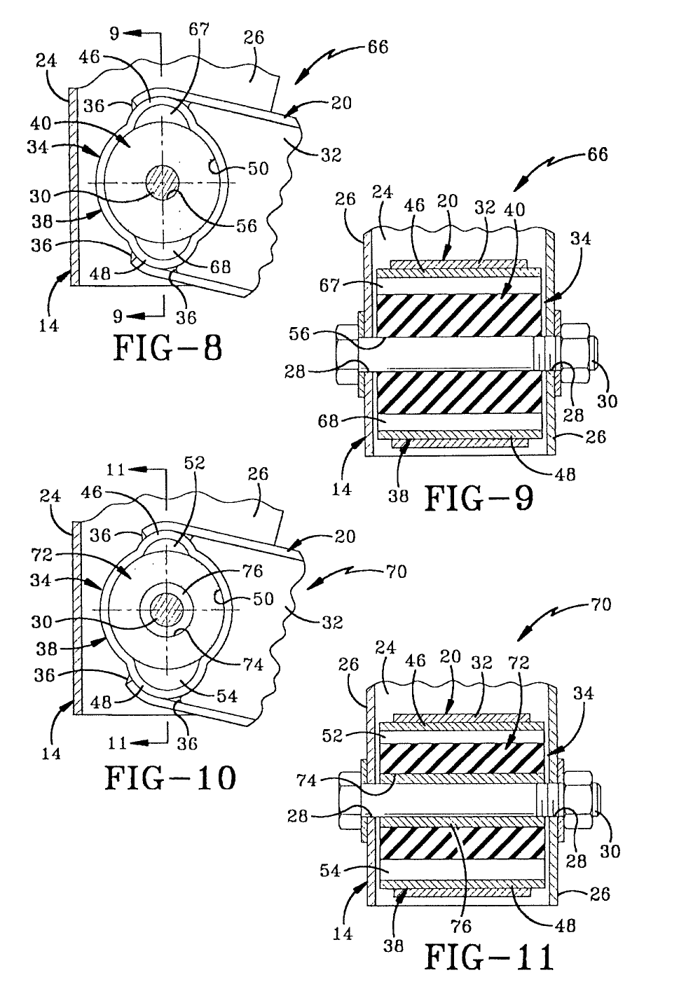

A second embodiment of the present invention is shown more particularly in FIGS. 8 and 9. The second embodiment of the present invention is shown generally as suspension system 66. Suspension system 66 is similar to suspension system 1 in every respect except that it includes a second cavity 67 and a third cavity 68. Second cavity 67 and third cavity 68 are similar to second cavity 52 and third cavity 54 except that they are identical in size, shape and configuration. As can be seen, second cavity 67 and third cavity 68 are sized identically, thus providing for a constant vertical compliance regardless of whether the forces act in the direction of arrow A or in the direction of arrow B.

FIGS. 10 and 11 show a third embodiment of the present invention. The suspension system of the present invention which is indicated generally at 70. The suspension system 70 is similar to suspension system 1 in every respect except that it includes a bushing 72 having a aperture 74 sized to receive an internal journal 76. Journal 76 has an outer diameter complimentary shaped to aperture 74, and an inner diameter sized to accept bolt 30. In this manner, journal 76 assures that less wear and tear will occur on bushing 72 as a result of the continuous rotational movement of bushing 72 around bolt 30. Additionally, forces acting through bolt 30 will be spread around a larger diameter as forces will act directly from bolt 30 through journal 76 and into bushing 72.

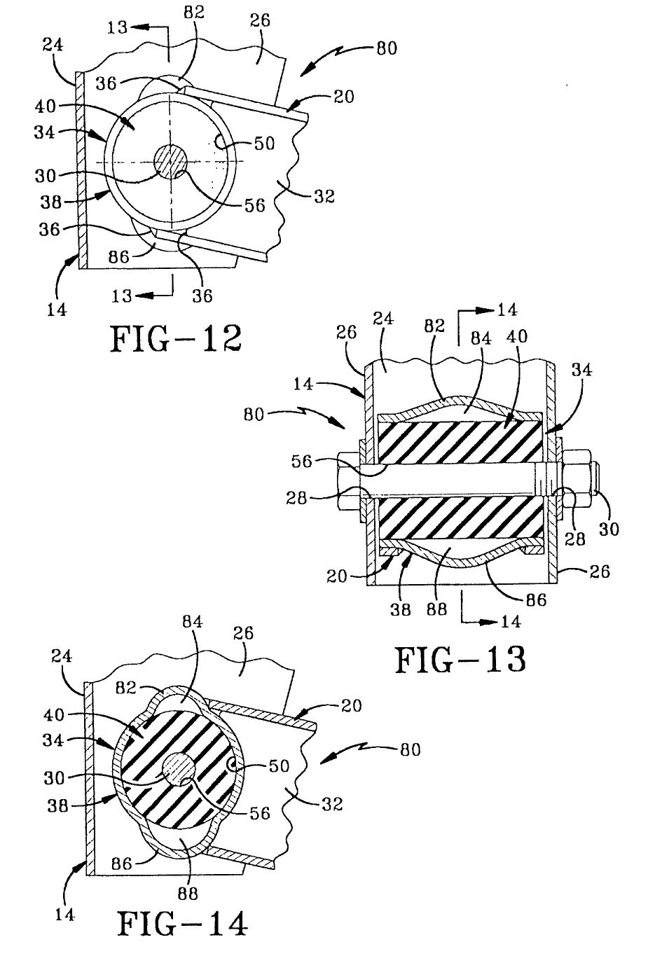

FIGS. 12, 13 and 14 show a fourth embodiment of the present invention where the fourth embodiment is indicated generally at 80 on the drawings. Suspension system 80 is similar to suspension system 1 in every respect except that it includes a top 82 forming a second cavity 84 and a bottom 86 forming a third cavity 88. Top 82 and bottom 86 form cavities 84 and 88 respectively such that cavities 84 and 88 do not extend entirely along the length of bushing 40. Instead, they provide a cavity only around the center of bushing 40, such that when force is applied along the direction of arrows A and B (FIGS. 6 and 7), the bushing will move fluidly into cavities 84 and 86, thus providing a more rigid vertical compliance. Still further, conically shaped cavities 84 and 88 will provide increased resistance to conical movement to bushing 40 and also may be varied in size to vary the effect of rotational forces acting on bushing 40.

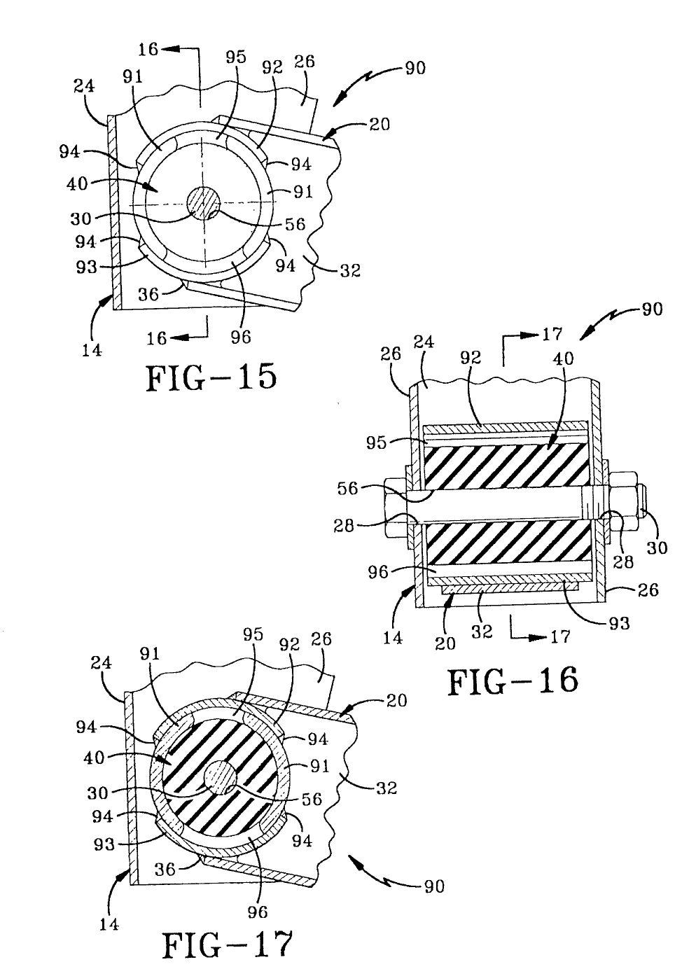

FIGS. 15, 16 and 17 picture a fifth embodiment of the suspension system 90 of the present invention. Suspension system 90 is similar to suspension system 1 in all respects except for the manner in which second and third cavities are formed. In the fifth embodiment of the suspension system 90 of the present invention shown in FIGS. 15, 16 and 17, two side plates 91 are provided along with a top plate 92 and a bottom plate 93. Side plates 91, top plate 92 and bottom plate 93 are welded at welds 94 to provide an upper cavity 95 and a lower cavity 96. Upper cavity 95 and lower cavity 96 operate identically to second cavity 52 and third cavity 54, but are formed in an alternative manufacturing method.

As can be seen from the variety of the embodiments set forth hereinabove, the size and location of the second and third cavity may vary substantially both in location relative to bushing 40, and in size relative to the bushing and to one another. Additionally, a single cavity or more then two cavities could be provided without departing from the spirit of the present invention. Still further, the bushing 40 may take a variety of configurations, including oval and square without departing from the spirit of the present invention.

Accordingly, the improved variable compliance pivot assembly is simplied, provides an effective, safe, inexpensive, and efficient device which achieves all the enumerated objectives, provides for eliminating difficulties encountered with prior devices, and solves problems and obtains new results in the art.

In the foregoing description, certain terms have been used for brevity, clearness, and understanding; but no unnecessary limitations are to be implied therefrom beyond the requirement of the prior art, because such terms are used for descriptive purposes and are intended to be broadly construed.

Moreover, the description and illustration of the invention is by way of example, and the scope of the invention is not limited to the exact details shown or described.

Having now described the features, discoveries, and principles of the invention, the manner in which the suspension assembly and associated bushing assembly is constructed and used, the characteristics of the construction, and the advantageous new and useful results obtained; the new and useful structures, devices, elements, arrangements, parts, and combinations are set forth in the appended claims.

1. A suspension system for supporting a vehicle comprising:
at least one beam adapted for supporting a vehicle;
a pivot assembly attached to one end of the beam, said pivot assembly including a bushing and a bushing seat; and
the bushing being non-complimentary shaped to the bushing seat.

2. The suspension system as defined in claim 1 in which the bushing seat has a first cavity sized to receive the bushing and in which the bushing is positioned within the first cavity, and at least one additional cavity formed in the bushing seat which additional cavity is in communication with the first cavity.

3. The suspension system as defined in claim 2 in which the first cavity and the bushing are complementary shaped.

4. The suspension system as defined in claim 3 in which the first cavity has a sidewall and a perimeter and in which the sidewall is discontinuous along the perimeter.

5. The suspension system as defined in claim 4 in which the bushing has an outer surface, and in which the outer surface of the bushing is in contact with the bushing seat sidewall and in which the bushing seat sidewall is not in contact with the bushing outer surface adjacent the additional cavity.

6. The suspension system as defined in claim 5 in which the bushing outer surface is smooth.

7. The suspension system as defined in claim 5 in which the outer surface is arcuate.

8. The suspension system as defined in claim 7 in which the outer surface is circular.

9. The suspension system as defined in claim 7 in which the radius of the outer surface varies about its circumference.

10. The suspension system as defined in claim 4 in which the perimeter wall of the first cavity has a first radius of curvature, and in which the additional cavity has an additional perimeter wall having a second radius of curvature; whereby the first radius of curvature differs from the second radius of curvature.

11. The suspension system as defined in claim 10 in which the second radius of curvature is smaller then the first radius of curvature.

12. The suspension system as defined in claim 10 in which the additional perimeter wall forms the additional cavity.

13. The suspension system as defined in claim 12 in which a third cavity is positioned in communication with the first cavity, and in which the third cavity is formed with a third perimeter wall, which third perimeter wall has a radius of curvature different from the first radius of curvature.

14. The suspension system as defined in claim 13 in which the third radius of curvature is smaller then the first radius of curvature.

15. The suspension system as defined in claim 2 in which the bushing seat has a length, and in which the first cavity and the additional cavity extend along the entire length.

16. The suspension system as defined in claim 15 in which the cross sectional configuration of the bushing seat is constant along the bushing seat length.

17. The suspension system as defined in claim 2 in which the bushing seat has a length, and in which the first cavity extends along the entire length, and in which the additional cavity extends along only a portion of the length.

18. The suspension system as defined in claim 17 in which the bushing seat has a length, and in which the cross sectional configuration of the bushing seat varies along the length.

19. The suspension system as defined in claim 18 in which the bushing seat has a pair of ends, and in which the bushing seat is wider intermediate the pair of ends than adjacent the pair of ends.

20. The suspension system as defined in claim 2 in which the additional cavity is concave.

21. The suspension system as defined in claim 2 in which the bushing has a constant cross sectional configuration, the bushing seat has a cross sectional configuration and in which the bushing seat cross sectional configuration differs from the bushing cross sectional configuration.

22. The suspension system as defined in claim 21 in which the difference between the cross sectional configuration of the bushing and the cross sectional configuration of the bushing seat defines a cavity, and in which the cavity provides for an area of deflection for the bushing when the bushing is under load.

23. The suspension system as defined in claim 4 in which the bushing is manufactured of elastomeric material, and in which the elastomeric material with the bushing is positioned within the first cavity when no load is placed on the bushing, and whereby the bushing moves at least partially into the additional cavity when the bushing is under load.

24. A suspension system for a vehicle comprising:
a bushing have a constant cross section;
a bushing seat having a cavity;
the bushing received within the cavity; and
the cavity being larger than the bushing to provide for deflection of the bushing.

25. The suspension system as defined in claim 24 in which the bushing seat contacts the bushing along a portion of the cavity and is free of contact with the bushing along other portions of the cavity.

26. The suspension system as defined in claim 25 in which the bushing is elastomeric, and moves within the cavity when the bushing deflects.

27. A method of controlling the deflection of the bushing comprising:
providing an elastomeric bushing;
providing a bushing seat having a first cavity surrounding at least a portion of the bushing;
providing at least a second cavity in communication with the first cavity and adjacent to bushing;
applying a first force on the bushing in a first direction;
reacting the first force on the wall of the first cavity;
applying a second force to the bushing in a direction different from the first force; and
deflecting the bushing at least partially into the second cavity as a result of the second force.

28. The method as defined in claim 27 in which the first force is a longitudinal force and the second force is a vertical force.

29. The method as defined in claim 28 in which the second cavity is concave.
